(19) United States
(12) Patent Application Publication
(10) Pub. No.: US 2014/0259124 A1
(43) Pub. Date: Sep. 11, 2014

(54) SECURE WIRELESS NETWORK CONNECTION METHOD

(71) Applicants: John Petersen, London (GB); Patrick Carroll, London (GB); Jonathan Mark Alford, London (GB); Zdenek Kalenda, Terwolde (NL)

(72) Inventors: John Petersen, London (GB); Patrick Carroll, London (GB); Jonathan Mark Alford, London (GB); Zdenek Kalenda, Terwolde (NL)

(21) Appl. No.: 14/347,414

(22) PCT Filed: Sep. 26, 2012
(86) PCT No.: PCT/GB2012/052388

§ 371 Date: Mar. 26, 2014

(30) Foreign Application Priority Data
Sep. 26, 2011 (GB) 1116529.7

(51) Int. Cl. H04W 12/06; H04L 29/06; H04W 12/08

(52) U.S. Cl. CPC H04W 12/06; H04W 12/08; H04L 63/08
USPC 726/4

(57) ABSTRACT

A method of connecting a user computing device to a wireless network comprises establishing a wireless connection between the user computing device and a first wireless network. The user provides identifying information to a server via the first wireless network. In response to the server authenticating the user and upon successful authorisation of the user having the appropriate rights, the user receives access information for a second wireless network from the server. The user computing device establishes a wireless connection to the second wireless network using the received access information. The method has the advantage that the first wireless network can be easily discoverable, whereas the second wireless network can have an enhanced level of security.

This invention relates to a method of connecting a user computing device to a wireless network, as well as a user computing device, server, data communication system and computer software for implementing the method.

### BACKGROUND

Wireless connectivity is a commonplace resource now in both residential, commercial and public sector/military environments. There has been a move from static systems with wired connections to laptops, tablets and handheld devices resulting in the availability and dependability of wireless network solutions becoming more important.

With a wireless network, there are risks that need to be reduced or, if possible, eliminated to ensure data integrity and security. Broadcasting data ‘over the air’ wirelessly introduces the risk that data is not directed just to the intended recipient, but to any recipient within range. So-called spoofing or impersonation of both sender and recipient introduces questions about whether the data transmitter- or receiver-party is a trusted party or not.

Authentication mechanisms serve as a means to identify peers connected to a network and encryption of data prior to transmission prevents eavesdropping and tampering. Using this system, a unique certificate is granted to devices upon having passed an initial verification process. The combination of these provides a very strong authentication, authorisation and accounting mechanism required for network access

### BRIEF SUMMARY OF THE DISCLOSURE

In accordance with the present invention there is provided a method of connecting a user computing device to a wireless network. The method comprises establishing a wireless connection between the user computing device and a first wireless network. The user provides identifying information to a server via the first wireless network. In response to the server validating the identifying information provided by the user, the user receives access information for a second wireless network from the server. The user computing device establishes a wireless connection to the second wireless network using the received access information. Validation of the identifying information may comprise authenticating the user, i.e. confirming the user's identity, and determining the authorisation of the user to access the second wireless network.

Thus, in accordance with the invention, the user computing device can connect to a first wireless network that can have a relatively low level of security. Connection to the first wireless network can be relatively simple for the user or even automatic. The user can obtain access information for a second wireless network that can have a higher level of security and/or encryption, or a user could be automatically joined to a second wireless network. In this way, the second wireless network does not need to be easily discoverable or accessible, which reduces the opportunities for unauthorised access to the second wireless network.

The user computing device may be, for example, a computer, a laptop computer, a tablet a personal digital assistant, a mobile telephone, a smartphone or any other suitable device capable of connecting to a wireless network. Typically, the user computing device will comprise a wireless network adapter. The wireless network adapter may be internal to the user computing device or may be external.

The first and/or second wireless networks may be a wireless local area network based on the IEEE 802.11 standard. However, other wireless network protocols may be used. It is not necessary for the first and the second wireless networks to operate using the same communications protocol.

The identifying information provided by the user computing device may be, for example, a username and password, an identifying code, or other similar identifier. The identifying information may be provided to the server via a secure connection, for example a secure socket layer (SSL) connection. The identifying information may be provided via a web application downloaded from the server by the user computing device. Alternatively, the user computing device may have software installed to provide the identifying information to the server.

As used herein, the term “server” is not limited to a single computer operating as a server and the term is used to include the possibility that the functionality of the “server” may be provided by a plurality of connected computers. For example, an access server may be provided to receive the identifying information from the user and a connected validation server may be provided to validate the identifying information.

Validation of the identifying information may require additional input from the user. For example, the user may be sent a validation code on a separate communication channel, for example via a mobile telephone, which must be provided to the server in order to complete the validation process.

In one embodiment of the invention, the user computing device receives the access information for the second wireless network from the server via the first wireless network. However, in embodiments of the invention the user is able to send and receive information, such as the access information, via a separate channel, for example via a mobile telephone. The advantage of the out of band factor is that, should a third party have acquired access to, or duplicated, a user device or credentials, the authentication process requires additional steps increasing the security factor.

The server may notify a network access controller of the second wireless network that access information has been issued to the user. In this case, the network access controller may then expect an access request from the user, for example within a predetermined time period. The access information may include time-limited access credentials, which may be provided as an alternative or in addition to, for example, a MAC address, IP address, digital certificate and/or encryption key which could be configured to be prerequisite data for access to the second wireless network. The prerequisite data may be shared with the network access controller by the server in order that the network access controller is able to recognise the data and attributes when they are processed and facilitate access to the second wireless network.

Typically, the first wireless network broadcasts a network identifier. The network identifier may be a service set identifier (SSID). Broadcasting a network identifier simplifies identification of the network for the user. The second wireless network may not broadcast a network identifier. However, the access information may include the network identifier of the second wireless network. In this way, the user is able to identify and gain access to the second wireless network even though the network identifier is not broadcast.

The access information may include a password for access to the second wireless network. In an embodiment of the invention, the access information includes a digital certificate for secure access to the second wireless network. The digital certificate may include an encryption key. The digital certificate may be installed on the user computing device to allow secure access to the second wireless network.

Typically, the user computing device disconnects from the first wireless network before establishing the wireless connection to the second wireless network.

A particular advantage of the present invention is that the user has the convenience of connecting to the first wireless network while maintaining the higher level of security of the second wireless network. Consequently, the method is typically carried out while the user computing device is within the communication range of both the first and the second wireless networks. Thus, the communication range of the two wireless networks may be substantially the same or have a substantial overlap.

Viewed from a further aspect, the invention provides a user computing device configured to establish a wireless connection to a first wireless network, communicate identifying information from a user to a server via the first wireless network, in response to the server validating the identifying information provided by the user, receive access information for a second wireless network from the server and establish a wireless connection to the second wireless network using the received access information.

The user computing device is typically configured to receive the access information for the second wireless network from the server via the first wireless network. The user computing device is typically configured to disconnect from the first wireless network before establishing the wireless connection to the second wireless network.

The invention also extends to computer software which configures a general-purpose computing device to operate as a user computing device in accordance with the invention. The computer software may take the form of an application that is installed on the user computing device and automatically carries out the steps of the invention. In this way, once the user has provided the identifying information, the user computing device may automatically receive the access information and connect to the second wireless network, disconnecting from the first wireless network as necessary.

Viewed from a yet further aspect, the invention provides a computer server configured to receive identifying information from a user computing device via a first wireless network, validate the identifying information provided by the user computing device, and in response to successful validation of the identifying information provided by the user computing device, communicate access information for a second wireless network to the user computing device. As explained above, the server may be provided by multiple interconnected computing devices.

The server may be configured to communicate the access information for the second wireless network to the user computing device via the first wireless network. The server may be configured to notify a network access controller of the second wireless network that access information has been issued to the user computing device.

The invention extends to computer software which configures a general-purpose computing device or a plurality of general-purpose computing devices to operate as a computer server according to the invention.

Viewed from a yet further aspect, the invention provides a data communication system comprising a first wireless device, an access server in data communication with the first wireless device and a second wireless device. The first wireless device is configured to establish data communication with a user computing device and to communicate identifying information from the user computing device to the access server. The access server is configured to validate the identifying information provided by the user computing device and, in response to successful validation of the identifying information, to communicate access information for a second wireless network to the user computing device via the first wireless device. The second wireless device is configured to establish data communication with the user computing device on receipt of the access information.

The system may further comprise a network access controller in data communication with the second wireless device. The access server may be configured to notify the network access controller that access information has been issued to the user computing device. The network access controller may control the operation of the second wireless device.

The system may further comprise a logging system to record events on the first wireless network, the authentication process, the authorisation process and/or events on the second wireless network. This feature provides accounting and audit capability in respect of each component and user of the system.

The first wireless device may be configured to broadcast a network identifier. The second wireless device may be configured to operate without broadcasting a network identifier. The access information may include the network identifier of the second wireless device.

Typically, the first wireless device and the second wireless device are located such that a user computing device within the communication range of the first wireless device is also within the communication range of the second wireless device. For example, the first wireless device and the second wireless device may be located in substantially the same location. Indeed, the first wireless device and the second wireless device may be provided as a single physical unit.

The system may further comprise multiple secondary networks that users may be permitted to use. Upon successful authentication of a user, authorisation is determined based on rights/permissions attributed to that user and that are accessible by a server. A user can then be granted access information to a second network based on an individual basis or on membership of a larger group such as department, company or clearance level. In an embodiment of the invention, a user from a sales department, via the first network, is provided access information for a secondary network. Additionally a user from a technical department, via the same first network, is provided access information to a different secondary network.

### BRIEF DESCRIPTION OF THE DRAWINGS

Embodiments of the invention are further described hereinafter with reference to the accompanying drawings, in which:

FIG. 1 is a schematic diagram illustrating the operation of an embodiment of the invention.

In broad terms, embodiments of the invention relate to a process in which a client device connects to a visible primary network which can provide a ‘limited’ set of services. The client device can authenticate itself on the primary network in order to obtain certificates to allow connection to a secondary network(s) running a security protocol that requires clients to present the obtained certificate. Thus, the method involves certificate acquisition on one wireless network and, based on that acquisition, allowing communication with and connection to another (private/secure) network based on permission associated with the certificate. In order to use a certificate dependent wireless network (network B), the client needs to present some certificate data in the negotiation process of joining. This requires the client to have previously obtained the certificate prior to attempting such a connection. According to an embodiment of the invention, a guest or lobby network (network A) is used for the clients to connect initially, for acquisition of certificates to be used with another desired network. The system attempts to validate a user or device intending to connect, obtain and present a certificate together with information where and how to utilise it (i.e. network B, C, D etc.). The client processes this information, attempts to connect to the network indicated and with the acquired certificate.

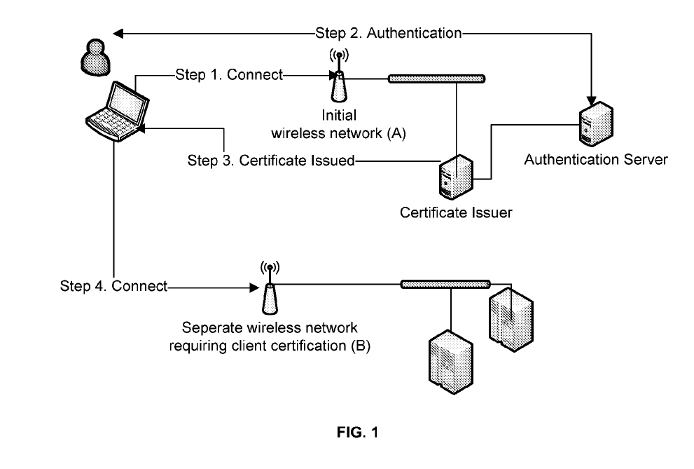

An embodiment of the invention is illustrated in FIG. 1. As shown in FIG. 1, in Step 1 a client computer (illustrated as a laptop computer) connects to a wireless network (network A), which is typically accessible to all clients without requiring passwords or certificates. The client computer then establishes a secure connection to a certificate issuer. Typically the certificate issuer is presented as a server to which the client computer can connect using a web browser or application. The certificate issuer may be a service running on a local, trusted, network resource or may be a certificate issuer which operates over the Internet or other remote network.

In Step 2, the client user can authenticate themselves to the certificate issuer using a variety of different methods, such as username, password, hardware signature, one time token, out of band verification, biometrics, or a combination of multiple factors to determine accuracy and increased security. The client user provides identifying information via the secure connection on the initial wireless network to the certificate issuer. The certificate issuer communicates with an authentication server to confirm the authenticity of the client user's identifying information and determine the authorisation permitted. This may require additional information from the client user.

Once the authentication server confirms that the user's credentials are authentic and the user's rights permit them access further, at Step 3, the certificate issuer creates or authorises a certificate and issues this to the client, to be transmitted securely, stored and registered locally on the client computer. In addition to the certificate, information is also passed securely to the client computer identifying the intended network (network B in this example) to which the client computer should connect using this certificate. The certificate and the identifying information is processed utilising a service, application, plug-in or similar implementation on the client computing device.

Once the certificate and network information have been safely received and stored, at Step 4 the client computer disconnects from the initial network and attempts to begin negotiation with the second wireless network in order to connect. Typically this network operates without broadcasting its identity (for example, its SSID), on separate infrastructure or using equipment capable of running multiple, segmented wireless networks to communicate with either the certificate issuer network or the more secure internal network(s). The client computer is now in a position to call upon the certificate and utilise aspects of the data available over the second wireless network (B) when required. This certificate data may be solely sufficient for the security requirements or can be utilised with other factors such as passwords.

After successful negotiation, the client computer is now a member of this second network and can connect directly whilst in possession of a valid and current client-held certificate. Such a certificate may have a short lifespan in order to increase security.

In summary, a method of connecting a user computing device to a wireless network comprises establishing a wireless connection between the user computing device and a first wireless network. The user provides identifying information to a server via the first wireless network. In response to the server authenticating the user and upon successful authorisation of the user having the appropriate rights, the user receives access information for a second wireless network from the server. The user computing device establishes a wireless connection to the second wireless network using the received access information. The method has the advantage that the first wireless network can be easily discoverable, whereas the second wireless network can have an enhanced level of security.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers and characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1-25. (canceled)

26. A method of connecting a user computing device to a wireless network, the method comprising:
establishing a wireless connection between the user computing device and a first wireless network;
the user providing identifying information to a server via the first wireless network;
in response to the server validating the identifying information provided by the user, the user receiving access information for a second wireless network from the server;
the user computing device establishing a wireless connection to the second wireless network using the received access information;
wherein the second wireless network does not broadcast a network identifier and the access information includes the network identifier of the second wireless network.

27. A method as claimed in claim 26, wherein the user computing device receives the access information for the second wireless network from the server via the first wireless network.

28. A method as claimed in claim 26, wherein the server notifies a network access controller of the second wireless network that access information has been issued to the user.

29. A method as claimed in claim 26, wherein the first wireless network broadcasts a network identifier.

30. A method as claimed in claim 26, wherein the access information includes a certificate for secure access to the second wireless network.

31. A method as claimed in claim 26, wherein the user computing device disconnects from the first wireless network before establishing the wireless connection to the second wireless network.

32. A method as claimed in claim 26, wherein the method is carried out while the user computing device is within the communication range of both the first and the second wireless networks.

33. A user computing device configured to:
establish a wireless connection to a first wireless network;
communicate identifying information from a user to a server via the first wireless network;
in response to the server validating the identifying information provided by the user, receive access information for a second wireless network from the server;
establish a wireless connection to the second wireless network using the received access information;
wherein the second wireless network does not broadcast a network identifier and the access information includes the network identifier of the second wireless network.

34. A device as claimed in claim 33, wherein the user computing device is configured to receive the access information for the second wireless network from the server via the first wireless network.

35. A device as claimed in claim 33, wherein the access information includes a certificate for secure access to the second wireless network.

36. A device as claimed in claim 33, wherein the user computing device is configured to disconnect from the first wireless network before establishing the wireless connection to the second wireless network.

37. Computer software which configures a general-purpose computing device to operate as a user computing device according to claim 33.

38. A computer server configured to:
receive identifying information from a user computing device via a first wireless network;
validate the identifying information provided by the user computing device;
in response to successful validation of the identifying information provided by the user computing device, communicate access information for a second wireless network to the user computing device;
wherein the second wireless network does not broadcast a network identifier and the access information includes the network identifier of the second wireless network.

39. A server as claimed in claim 38, wherein the server is configured to communicate the access information for the second wireless network to the user computing device via the first wireless network.

40. A server as claimed in claim 38, wherein the server is configured to notify a network access controller of the second wireless network that access information has been issued to the user computing device.

41. A server as claimed in claim 38, wherein the access information includes a network identifier of the second wireless network.

42. A server as claimed in claim 38, wherein the access information includes a certificate for secure access to the second wireless network.

43. Computer software which configures a general-purpose computing device or a plurality of general-purpose computing devices to operate as a computer server according to claim 38.

44. A data communication system comprising:
a first wireless device;
an access server in data communication with the first wireless device; and
a second wireless device,
wherein the first wireless device is configured to establish data communication with a user computing device and to communicate identifying information from the user computing device to the access server,
wherein the access server is configured to validate the identifying information provided by the user computing device and, in response to successful validation of the identifying information, to communicate access information for a second wireless network to the user computing device via the first wireless device, and
wherein the second wireless device is configured to establish data communication with the user computing device on receipt of the access information; and
wherein the second wireless device is configured to operate without broadcasting a network identifier and the access information includes the network identifier of the second wireless device.

45. A system as claimed in claim 44, wherein the system further comprises a network access controller in data communication with the second wireless device and the access server is configured to notify the network access controller that access information has been issued to the user computing device.

46. A system as claimed in claim 44, wherein the first wireless device is configured to broadcast a network identifier.

47. A system as claimed in claim 44, wherein the access information includes a certificate for secure access to the second wireless device.

48. A system as claimed in claim 44, wherein the first wireless device and the second wireless device are located such that a user computing device within the communication range of the first wireless device is also within the communication range of the second wireless device.
